(19) United States
(12) Patent Application Publication
(10) Pub. No.: US 2017/0082477 A1
(43) Pub. Date: Mar. 23, 2017

(54) Remote Gas Cylinder Measurement System and Methods

(71) Applicants: Anthony Zane Lee, Molena, GA (US); Daniel B. Seevers, Suwanee, GA (US); Donald A. Collins, JR., Buford, GA (US)

(72) Inventors: Anthony Zane Lee, Molena, GA (US); Daniel B. Seevers, Suwanee, GA (US); Donald A. Collins, JR., Buford, GA (US)

(21) Appl. No.: 15/219,085

(22) Filed: Jul. 25, 2016

Related U.S. Application Data
(60) Provisional application No. 62/220,679, filed on Sep. 18, 2015.

(51) Int. Cl. G01F 23/20; G01F 23/00

(52) U.S. Cl. CPC G01F 23/20; G01F 23/0061

(57) ABSTRACT

The present invention relates to a system and method of remotely sensing the fill level of liquefied gas within containers. There are many gas types which are compressed into liquid form to fit into many sizes of cylinders for many purposes. Principal gas types are nitrogen, oxygen, carbon dioxide, argon, hydrogen, helium, and acetylene. More specifically, this invention relates to an apparatus and method of remotely determining the remaining liquefied gas which is present in the cylinder and reporting it through an internet website or messaging system to the business responsible for keeping the cylinder filled. The chief benefit of the system is to eliminate two situations; 1) a replacement tank is dispatched when none is needed, and 2) the user of the tank, i.e. a restaurant, runs out of gas and there is no replacement gas available for some time. Both situations cause customer aggravation or increased costs.

### CROSS REFERENCE TO RELATED APPLICATIONS

This non-provisional application claims the benefit of prior filed provisional Application No. 62/220,679, entitled “Remote Gas Cylinder Measurement System”, filed Sep. 18, 2015. Application No. 62/220,679 is incorporated herein by reference.

### STATEMENT REGARDING FEDERALLY SPONSORED RESEARCH OR DEVELOPMENT

Not Applicable.

### DESCRIPTION OF ATTACHED APPENDIX

Not Applicable.

### BACKGROUND

Delivering gas cylinders is a technical logistics problem. If a restaurant runs out of CO2 gas, patrons may be dissatisfied with the drink quality and may not return, costing the restaurant future business. On the other hand, if a supplier delivers gas before on-site cylinders are empty, time and cost in the form of labor, wear on trucks, and fuel are wasted. It is the goal of the present invention to reduce gas cylinder delivery trips (cost), but never allow a cylinder to run out of gas at a customer's business, by remotely reporting the rate of usage more accurately to the supplier of the gas.

The present invention relates to a system and method of remotely sensing the fill level of liquefied gas within gas cylinders. There are many gas types which are compressed into liquid form to fit into many sizes of cylinders for many purposes. Principal gas types are acetylene, argon, carbon dioxide, helium, hydrogen, oxygen, and nitrogen or combinations thereof. More specifically, this invention relates to an apparatus and method of remotely determining the remaining gas which is present in the cylinder and reporting it through an internet website or messaging system to the business responsible for keeping the cylinder filled. The chief benefit of the system is to eliminate two situations; 1) a replacement tank is dispatched when none is needed, and 2) the user of the tank, i.e. a restaurant, runs out of gas and there is no replacement gas available for some time. Both situations cause customer aggravation or increased costs.

The Compressed Gas Association with 651 members reports that the North American gas market is $19B with 1000 suppliers of gases managing 100,000,000 cylinders in circulation driving gas cylinders 375,000,000 miles to be used in 6,896 hospitals serviced, 659 factories serviced, and 1 million restaurants in United States.

### PRIOR ART

PATENT CITATION 1: JP-A-2005-240854—Various techniques have been proposed to display the remaining amount of a compressed gas stored in a cylinder. The technique disclosed in this publication displays the remaining amount of a compressed gas fuel (compressed gas) stored in a cylinder, based on the pressure and calculated mass of the compressed gas fuel with no mention of remote measurement.

PATENT CITATION 2: JP-A-2006-226511—The technique disclosed in this publication displays the remaining amount of a compressed gas fuel (compressed gas) stored in a cylinder, based on the pressure and calculated mass of the compressed gas fuel with no mention of remote measurement.

PATENT CITATION 3: JP-A-2005-283127—The technique disclosed in this publication displays the remaining amount of a compressed gas fuel (compressed gas) stored in a cylinder, based on the pressure and calculated mass of the compressed gas fuel with no mention of remote measurement.

However, all above listed prior products/service are deficient in their ability to handle most gas cylinder sizes and to communicate via WIFI to a remote server running software programs which can email, text, call, or report the fill condition of millions of tanks to many customers simultaneously.

### SUMMARY

The management of gas cylinder systems, demands a high level of attention to measurement accuracy and timeliness of reporting and record storage. Thus, users will have confidence and trust in the measurement and reporting system and will pay for it.

In accordance with the teachings of the present invention, a system and method of accurately remotely measuring and reporting gas fill levels within cylinders is provided.

It is accordingly an object of the present invention to provide the most accurate electro-mechanical system and timely remote reporting and storage method of gas fill levels within cylinders placed at remote business locations.

It is another object of the present invention to provide the most electronically traceable reporting system and method of accurately measuring gas fill levels in remote cylinders over time for the purpose of minimizing cylinder transport, managing inventory, and creating an accurate billing system.

It is another object of the present invention to provide the most convenient electronic system and method for accurately measuring gas fill levels in remote cylinders in order to maximize the efficiency of gas cylinder transport and to maximize end user customer satisfaction.

The present invention comprises, in general, gas cylinders filled to various levels of liquefied gas to be measured, sitting atop a housing which includes a water resistant enclosure surrounding a weigh plate, sitting atop a weigh scale base with four load cells each with strain gauges located with equal radii in a circle, all wired to battery powered electronics comprised of a voltage summing circuit adding those four strain gauge outputs together for input into an amplifier and analog-to-digital converter circuit to condition, sample, and digitize the values over time all controlled by a microprocessor with memory which also receives remote requests for weight then provides the values from the analog-to-digital converter to a WIFI radio for communications between the microprocessor and a WIFI connected device such as a personal computer in the building holding the gas cylinders, that personal computer connected to the Internet, that Internet connected to a server which is running software to initiate measurement requests to remote devices, to store measurement data, to mathematically manipulate measurement data, to time-stamp measurement data, to make measurement data available by way of email, texts, or reports on web sites to users.

In use, the present invention functions to remotely monitor and notify users when it is time to refill a gas cylinder by email, texts, or reports on websites to users.

An alternate embodiment of present invention comprises all manner of sensors for example, an optical sensor which senses the state of a door (whether it is opened or closed) wired to battery powered electronics comprised of an amplifier and analog-to-digital converter circuit to condition, sample, and digitize the values over time all controlled by a microprocessor with memory which also receives remote requests for status then provides the values from the analog-to-digital converter to a WIFI radio for communications between the microprocessor and a personal computer in the building with the doors, that personal computer connected to the Internet, that Internet connected to a server which is running software to initiate measurement requests to remote devices, to store measurement data, to mathematically manipulate measurement data, to timestamp measurement data, to make measurement data available by way of email, texts, or reports on web sites to users.

An alternate embodiment of present invention comprises all manner of sensors for example, an optical sensor which senses the fill level of a liquid container (such as at a crude oil storage facility) wired to battery powered electronics comprised of an amplifier and analog-to-digital converter circuit to condition, sample, and digitize the values over time all controlled by a microprocessor with memory which also receives remote requests for status then provides the values from the analog-to-digital converter to WIFI radio for communications between the microprocessor and a WIFI device such as a personal computer on site, that personal computer connected to the Internet, that Internet connected to a server which is running software to initiate measurement requests to remote devices, to store measurement data, to mathematically manipulate measurement data, to timestamp measurement data, to make measurement data available by way of email, texts, or reports on websites to users.

### ADVANTAGES OF THE INVENTION

Another feature of the present invention is its ability to quickly and accurately measure and convey gas cylinder fill levels to users remotely and in a timely fashion

A feature of the present invention is its ability to be easily scaled up to millions of cylinders and/or users.

Another feature of the present invention is its ability to be installed and maintained by untrained users since there is no on-site programming needed and the data readings are in pounds.

### BRIEF DESCRIPTION OF THE DRAWINGS

Additional benefits and advantages of the present invention will become apparent to those skilled in the art to which this invention relates from the subsequent description of the preferred embodiments and the appended claims, taken in conjunction with the accompanying drawings, in which:

FIG. 1 is a table view of various cylinder sizes and materials;

FIG. 2 is a perspective view of a customer site with cylinder 01;

FIG. 3 is a system block diagram;

FIG. 4 is a housing block diagram;

FIG. 5 is a front view of a customer's cylinder atop a housing;

FIG. 6 is a flow chart showing a customer query for status;

FIG. 7 is a flow chart showing the program acquiring data;

FIG. 8 is a cell phone screen shot showing two customer cylinder statuses; and,

FIG. 9 is a cell phone text message screen showing hourly updates.

### DESCRIPTION

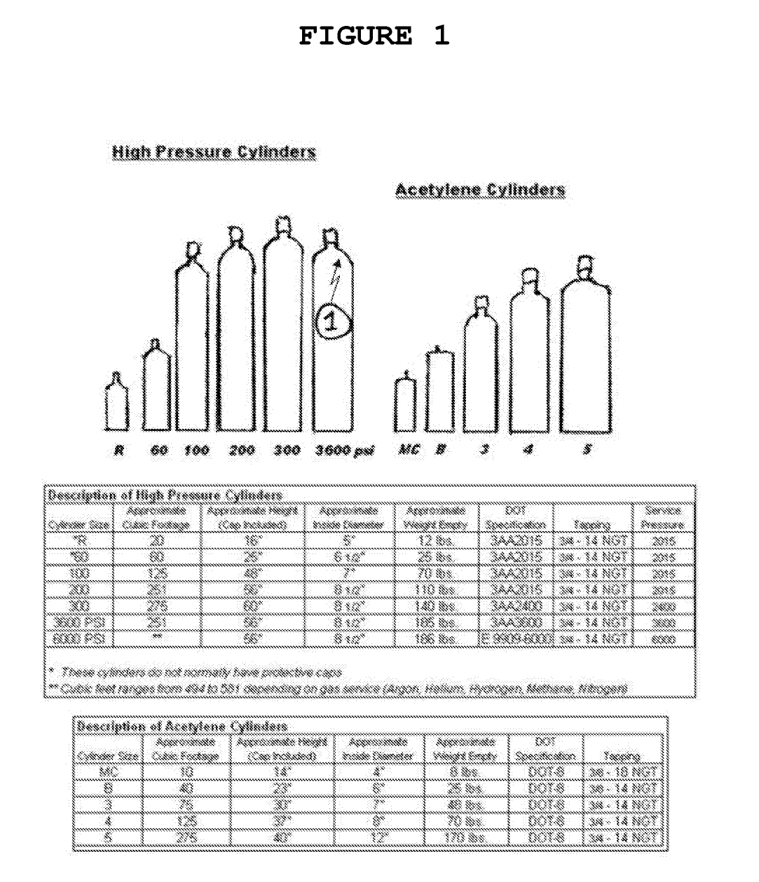

Referring now to FIG. 1, see a comparison of various gas cylinder sizes and characteristics such as tare weight (where no liquefied gas is present) with valve, height, capacity, pressure limits, and DOT specifications. The present invention can measure gas fill level in cylinders which weigh more than 49 pounds and less than 1001 pounds.

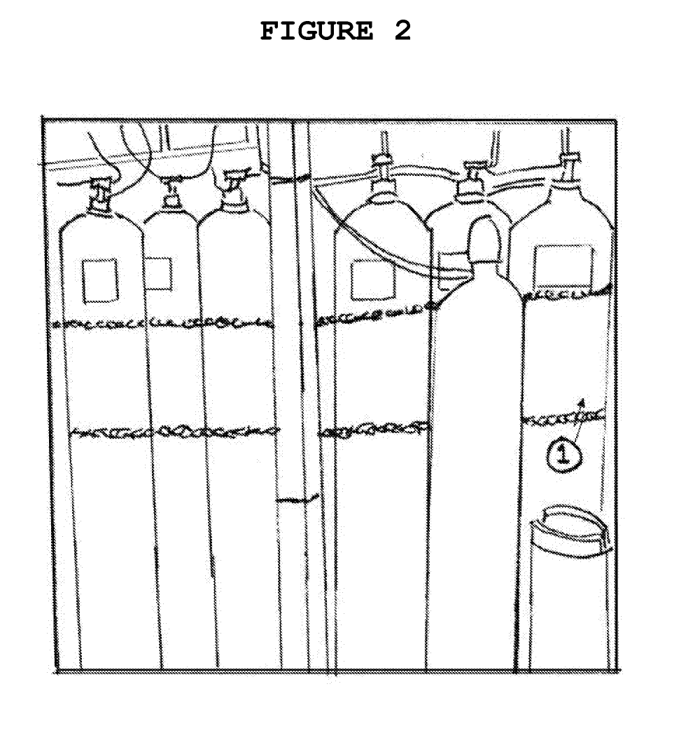

Referring now to FIG. 2, illustrating a customer's CO2 gas cylinder setup showing cylinder 01 to be measured. As is typical done, cylinder 01 gas output is tied by valve in parallel with other cylinders so that the level of all of those parallel cylinders will be equal. Thus, by measuring the fill level of cylinder 01, one can ascertain the fill level of all of the cylinders in parallel with cylinder 01.

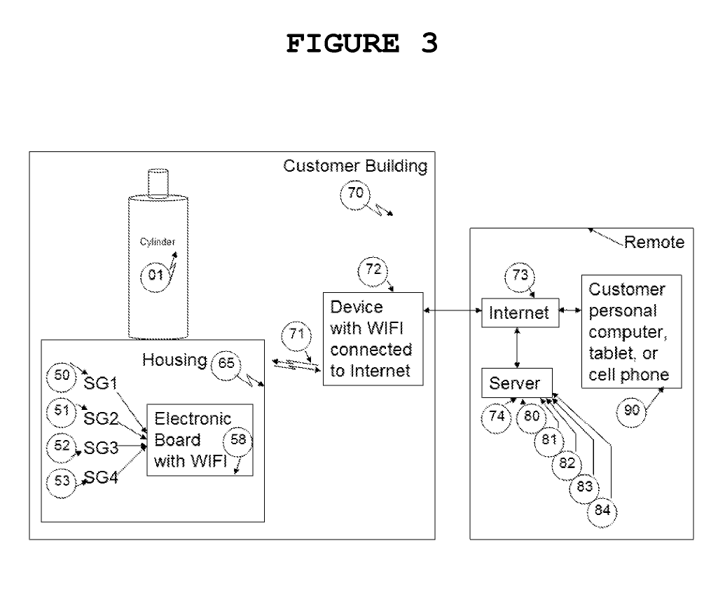

Referring now to FIG. 3, illustrating a diagram of the system configuration. In general, gas cylinder 01 filled to various levels of liquefied gas to be measured, sits atop housing 65 containing electronics board 58 which receives remote requests for fill status, then measures strain gauge data and provides the fill status values by WIFI communications 71 to a device like a personal computer or hot spot 72 in the customer's building 70 holding the gas cylinders, so that internet connected device 72 is connected to the Internet 73 which is connected to server hardware 74 which is running software 80 to initiate measurement requests to remote devices, software 81 to store measurement data, software 82 to mathematically manipulate (average, compare to thresholds, etc) measurement data, software 83 to time-stamp measurement data as it is acquired, and software 84 to make measurement data available by way of email, texts, phone calls or reports on websites to users.

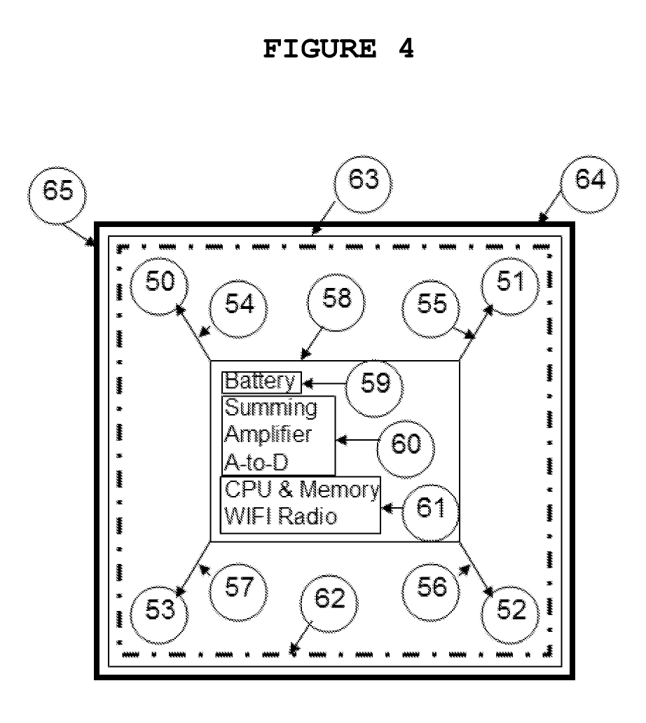

Referring now to FIG. 4, illustrating a block diagram of the housing 65 which includes a water resistant enclosure 64 surrounding a weigh plate 63, sitting atop a weigh scale base 62 with four strain gauges 50, 51, 52, 53, located at equal radii from the center of a circle, connected with wires 54, 55, 56, 57 respectively to electronic circuit board 58, powered be battery 59, including electronics comprised of a voltage summing circuit adding those four strain gauge 50, 51, 52, 53 outputs together for input into an amplifier and analog-to-digital converter circuit 60 to condition, sample, and digitize the values and controlled by a CPU microprocessor with memory 61 including WIFI radio for receiving requests for and sending gas fill level status.

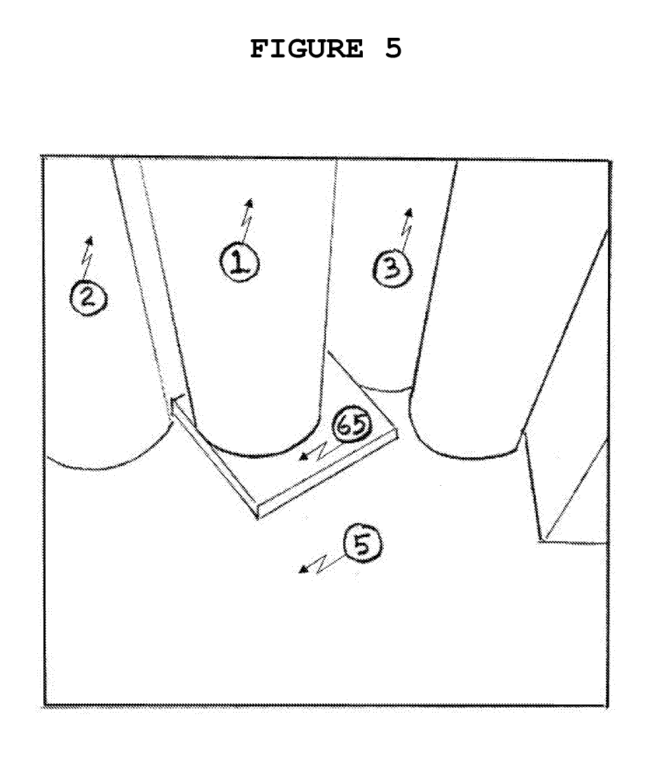

Referring now to FIG. 5, illustrating an actual customer installation at a brewery, cylinder 01 to be measured sitting atop housing 65, which includes all sensors and circuitry previously described, sitting atop customer building floor 05. Adjacent cylinders 02 and 03 are being measured indirectly because they are pneumatically in parallel with cylinder 01.

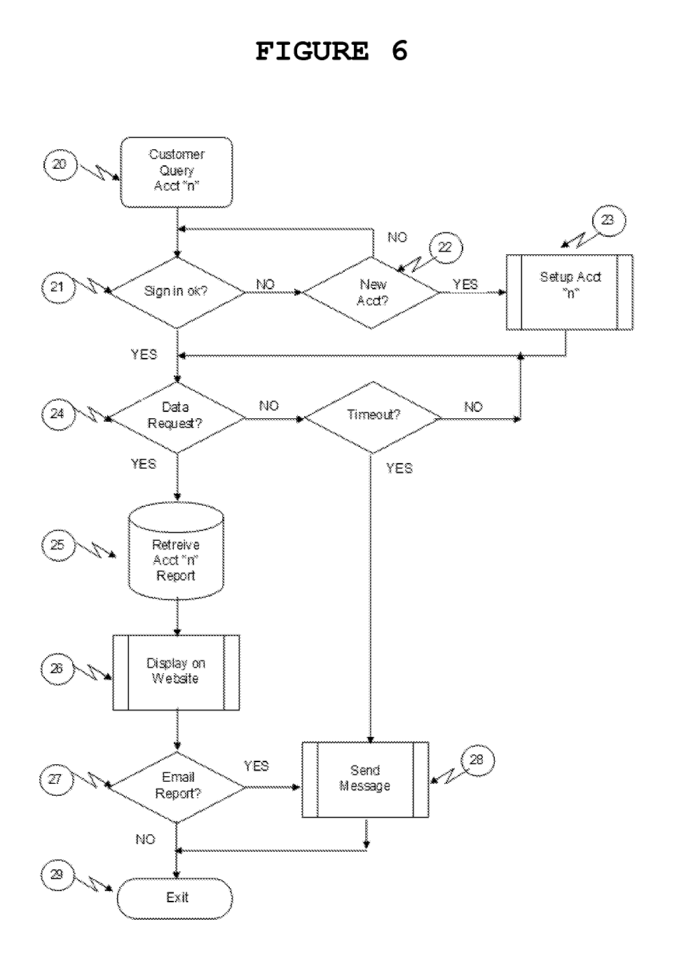

Referring now to FIG. 6, showing a flow diagram of a customer status inquiry. In general a customer will sign in to the website software 20 using their credentials to gain access 21. If they have no credentials 22, then they can create an account becoming a member of the website software 23. Next the customer can make a request to see the data associated with their account 24 whereby the software will retrieve their data 25 from the server and display it in a logical fashion on the website 26 for the customer to see and store. In addition the software gives the customer the option to have their data sent to them via email or text message 28.

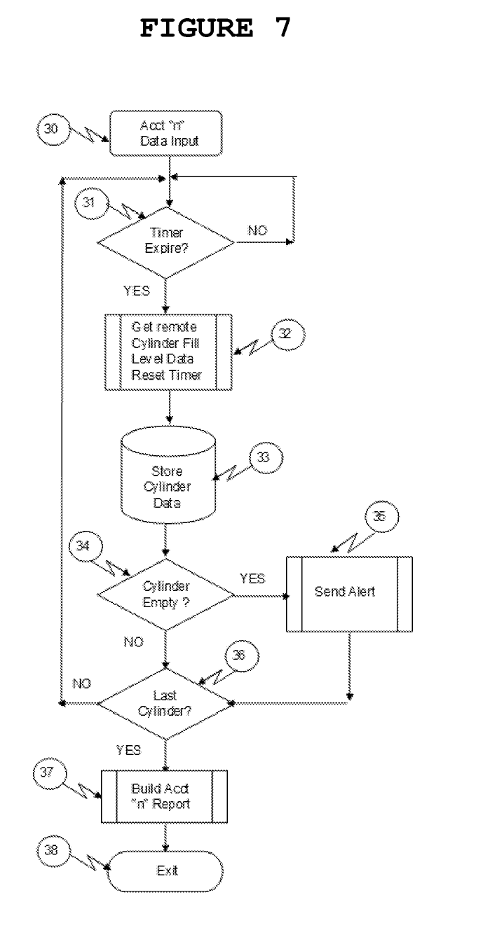

Referring now to FIG. 7, showing a flow diagram of system data inquiry and storage. In general, there will be scheduling software that runs this logic periodically for each account. Account “n” 30 will gather all of the data associated with that account periodically at predefined intervals. Typically, it is sufficient for the server software to query each account one time per day; however, one time per hour, per minute, or per second is possible. The server software will send a message to each cylinder within each building 32, storing the data then advancing to query data from the next cylinder in the building until all cylinders within the building are accounted for, then it will advance to the next building in the account until data for all buildings, the entire account 36 is stored at which point a report 37 will be generated. If the customer has requested an alert if the software detects an out of gas situation, then an alert 36 will be sent by message to that customer for every cylinder that is nearing some predefined low gas level.

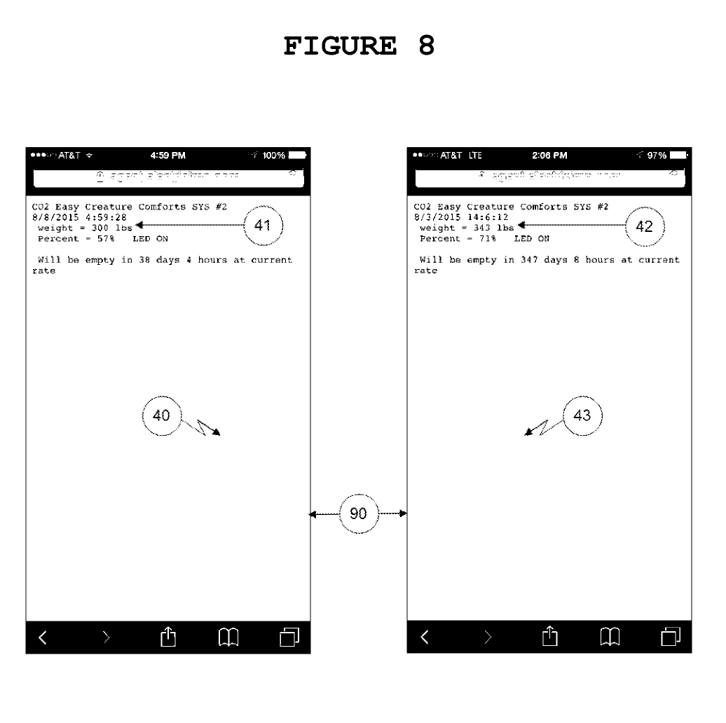

Referring now to FIG. 8, illustrating a customer cell phone screens showing times and dates and cylinder fill data. In this prototype system, whenever the customer refreshed their internet connection with their cell phone, then the data 41 or 43 was instantly available on their cell phone 90 screen 40 or 42. Observe that screen 40 was captured on Aug. 3, 2015 at 14:06:12 whereas screen 42 shows data captured 5 days later on Aug. 8, 2015 at 4:59:28. During this approximately 111 hour timeframe, 43 lbs of CO2 gas was used; however, the tank is not empty until the reading reaches 185 pounds as shown in FIG. 1 for the empty weight of a Dot Specification 3AA3600 cylinder.

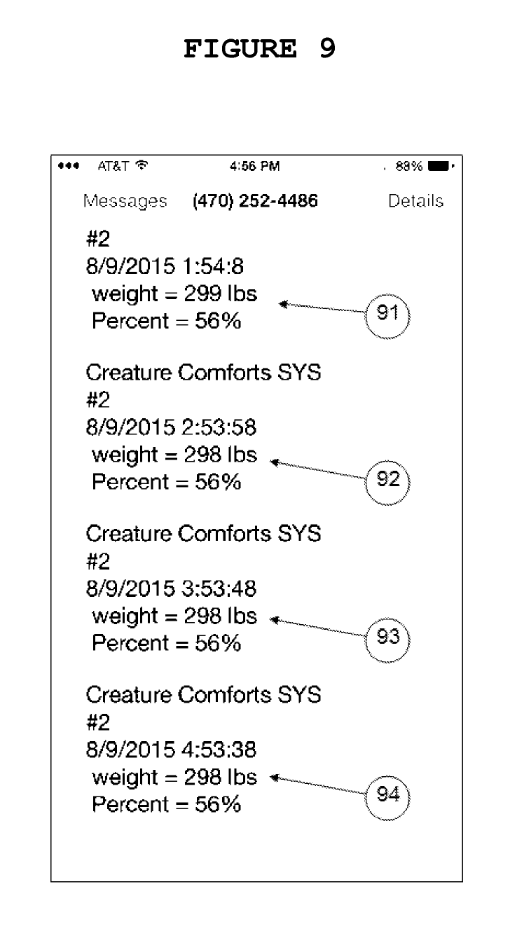

Referring now to FIG. 9, illustrating a customer cell phone screen showing times and dates and cylinder fill data. In general, text messages 91, 92, 93, 94 are sent to the customer's cell phone at a predefined hourly rate. These can also be sent as email messages at any predefined rate greater than 1 minute.

The above described system including all of the above functions with weigh scales, summing and amplifier board, cables, controller board, personal computers, network connections, programs, and data can be considered acceptable for use as remote gas cylinder measurement system. This system can be replicated to address all types of specialty gas markets located geographically anywhere there is internet service.

Although the invention has been described with particular reference to certain preferred embodiments thereof, variations and modifications of the present invention can be effected within the spirit and scope of the following claims. It is evident that those skilled in the art may now make numerous other uses and modifications of and departures from the specific embodiments described herein without departing from the inventive concepts.

PROTOTYPE—Three versions of prototype were constructed and tested, an early version of which was installed successfully in a customer site on Jul. 28, 2015. It continues to function to this day acceptably. Illustrations of the setup are shown in FIGS. 2 and 5 and a sample of the data collected is shown in FIG. 8.

What is claimed is:

1. A system to determine the amount of liquified gas remaining inside a container, the system comprising:
a. a housing configured to support the entire weight of said container;
b. a substantially rigid weigh plate supporting the weight of said container and said housing;
c. a plurality of load cells coupled between said weigh plate and a weigh scale base, the plurality of strain gauges operative to collectively support substantially all of the weight resting on said weigh plate, including the weight of said container;
d. the system further characterized in that the plurality of strain gauges are disposed with respect to the weigh plate such that each load cell weighs a portion of the weight of said container;
e. said plurality of strain gauges each operative to produce an analog voltage in a known proportion to the weight supported by each load cell;
f. a microprocessor controlled electronic circuit board operative to: sample said analog voltages produced by said plurality of strain gauges; and, produce a digitized weight value that is representative of the weight of said container;
g. said microprocessor controlled electronic circuit board interacts with an on board memory and is operative to send and receive data to and from, respectively, a communication network;
h. said microprocessor controlled electronic circuit board being further operative to respond to data received from said communication network by: sampling said analog voltages, producing said digitized weight value, and sending said digitized weight value to said communication network.

2. The system of claim 1 further characterized in that the analog voltages produced by said plurality of strain gauges are summed together into a single analog voltage before the microprocessor controlled electronic circuit board produces a digitized weight value that is representative of the weight of said container.

3. The system of claim 1 further characterized in that each of the plurality of said strain gauges is disposed at equal radii from a single center.

4. The system of claim 1 further characterized in that the microprocessor controlled electronic circuit board is further operative to store an empty weight value that corresponds to the weight of said container when said container is empty of any of said liquified gas.

5. The system of claim 1 further characterized in that the microprocessor controlled electronic circuit board is further operative to store a full weight value that corresponds to the weight of said container when said container is full of said liquified gas.

6. The system of claim 4 further operative to produce a digitized weight value that is the difference between said empty weight value and said digitized weight value, said difference being substantially the weight of liquified gas remaining in said container.

7. The system of claim 5 further operative to produce a digitized weight value that is the difference between said full weight value and said digitized weight value, said difference being substantially the weight of liquified gas that escaped said container after it was filled.

8. The system of claim 1 further characterized in that the microprocessor controlled electronic circuit board is further operative to initiate said sampling of said analog voltages and store one or more digitized weight values in said memory, the system further operative to send one or more previously digitized weight values to said communication network.

9. The system of claim 8 further characterized in that the microprocessor controlled electronic circuit board is further operative to initiate said sampling at periodic intervals, the period of said periodic intervals being determined by data stored in said memory.

10. The system of claim 8 further characterized in that the microprocessor controlled electronic circuit board is further operative to send one or more previously digitized weight values to said communications network at periodic intervals, the period of said periodic intervals being determined by data stored in said memory.

11. The system of claim 1 wherein the container has an empty weight between about 1 pound and about 1001 pounds.

12. The system of claim 1 wherein the container has a filled weight between about 2 pounds and about 5001 pounds.

13. The system of claim 1 further characterized in that: the housing is substantially water resistant; the microprocessor controlled electronic circuit board additionally comprises a battery; and, the microprocessor controlled electronic circuit board communicates with the communications network wirelessly.

14. The system of claim 1 wherein the digitized weight value that is sent to said communication network is a human readable digitized weight value.

15. The system of claim 14 wherein the human readable digitized weight value is sent to said communication network in a text message or in an email message.

16. The system of claim 1 in which said liquified gas comprises one substance from the following list {ammonia, butane, carbon dioxide chlorine, nitrous oxide, propane, sulfur dioxide}.

17. The system of claim 1, the container being further characterized in that it comprises a valve that is operative to allow internal gas pressure to escape outside the container over time, further characterized in that said microprocessor controlled electronic circuit board is operative to produce periodic digitized weight values over time that correspond to liquified gas remaining in the container.

18. The system of claim 17 in which said liquified gas comprises one substance from the following list {nitrogen, hydrogen, oxygen, carbon dioxide}
